(19) United States
(12) Patent Application Publication
(10) Pub. No.: US 2018/0267351 A1
(43) Pub. Date: Sep. 20, 2018

(54) LIQUID CRYSTAL PANEL WITH TOUCH SENSING FUNCTION AND LIQUID CRYSTAL DISPLAY DEVICE

(71) Applicant: NITTO DENKO CORPORATION, Ibaraki-Shi, Osaka (JP)

(72) Inventors: Satoshi Yamamoto, Ibaraki-shi (JP); Tomoyuki Kimura, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 15/763,913

(22) PCT Filed: Sep. 20, 2016
(86) PCT No.: PCT/JP2016/077720

§ 371 Date: Mar. 28, 2018

(30) Foreign Application Priority Data
Sep. 29, 2015 (JP) 2015-191664

(51) Int. Cl. G02F 1/1333; B32B 7/12; B32B 27/30; G06F 3/041; G02F 1/1335

(52) U.S. Cl. CPC G02F 1/13338; B32B 7/12; B32B 27/308; G06F 3/0412; G02F 2001/133567; B32B 2457/208; G02F 2202/28; G02F 2202/22; G02F 2001/133562; G02F 1/133528

(57) ABSTRACT

Provided is a liquid crystal panel with touch sensing function that can satisfy a stable antistatic function even in a humidity environment. The liquid crystal panel incorporated with touch sensing function is a1 panel including a liquid crystal cell incorporated with touch sensing function, a first polarizing film arranged on a viewing side of the cell and a second polarizing film arranged on a side of the cell that is opposite to the viewing side, and a first pressure-sensitive adhesive layer arranged between the first polarizing film and the cell. In the panel, the first pressure-sensitive adhesive layer includes a pressure-sensitive-adhesive composition including a (meth) acrylic polymer (A) including, as monomer units thereof, an alkyl (meth) acrylate (a1) and an amide-group-containing monomer (a2), and an ionic compound (B). This panel is small in surface resistance value variation even in a humidity environment.

### TECHNICAL FIELD

The present invention relates to a liquid crystal panel with touch sensing function, and a liquid crystal display device. The liquid crystal display device of the present invention with touch sensing function is usable as various inputting displays for mobile instruments and others.

### BACKGROUND ART

In a liquid crystal display device, from the viewpoint of the image forming manner thereof, polarizing films are generally bonded, respectively, to both sides of a liquid crystal cell through pressure-sensitive adhesive layers. A device in which a touch panel is mounted on a display screen of a liquid crystal display device has been put into practical use. For the touch panel, various modes are used, examples thereof including a capacitance mode, resistance membrane mode, an optical mode, an ultrasonic mode, and an electromagnetic induction mode. In many cases, however, the capacitance mode has come to be adopted. In recent years, as a touch sensor section, a liquid crystal display device with touch sensing function has been used, which a capacitive sensor is built in.

In the meantime, in the production of a liquid crystal display device, at the time of bonding its pressure-sensitive adhesive layer attached polarizing films to a liquid crystal cell, release films are peeled off, respectively, from the pressure-sensitive adhesive layers of the pressure-sensitive adhesive layer attached polarizing films. However, the peeling of the release films generates static electricity. The thus generated static electricity affects the alignment of a liquid crystal layer inside the liquid crystal display device to cause a defect of the display. The generation of the static electricity can be restrained, for example, by forming an antistatic layer on an outside surface of each of the polarizing films.

About the capacitive sensor of the liquid crystal display device with touch sensing function, when a user's finger is brought near to the surface of this sensor, the capacitive sensor detects a feeble capacitance generated by the transparent electrode pattern and the finger. When a conductive layer such as an antistatic layer is present between the transparent electrode pattern and the user's finger, an electric field is disturbed between the driving electrode and the sensor electrode so that the capacitance of the sensor electrode is made unstable. Consequently, the touch panel is lowered in sensitivity to cause a malfunction. In the liquid crystal display device with touch sensing function, it is required that the generation of static elasticity is restrained and further malfunctions of its capacitive sensor are restrained. For example, against the above-mentioned problem, it is suggested in a liquid crystal display device touch sensing function that a polarizing film having an antistatic layer having a surface resistance value of 1.0×10⁹ to 1.0×10¹¹ Ω/□ is located at the viewing side of a liquid crystal layer in order to decrease the generation of display defects or malfunctions (Patent Document 1).

Additionally, a pressure-sensitive adhesive for optical films is suggested which has an antistatic function for the purpose of preventing an unevenness of a liquid crystal panel that is based on static electricity or the adhesion of an alien substance to the panel, and for other purposes.

### PRIOR ART DOCUMENT

### Patent Document

Patent Document 1: JP-A-2013-105154

### SUMMARY OF THE INVENTION

### Problems to be Solved by the Invention

According to the antistatic layer attached polarizing film described in Patent Document 1, the generation of static electricity can be somewhat restrained. However, in Patent Document 1, a spot of the film where the antistatic layer is located is apart from a fundamental position thereof where static electricity is generated. Thus, this case is less effective than in the case of giving an antistatic function to a pressure-sensitive adhesive layer.

A pressure-sensitive adhesive layer containing an ionic compound further restrains the generation of static electricity than the above-mentioned antistatic layer located on the polarizing film, so as to be effective for preventing static electricity unevenness. However, it has been understood that the pressure-sensitive adhesive layer containing an ionic compound is deteriorated in antistatic function with time. In particular, in a humidity environment (after a humidity reliability test), the following has been understood: the ionic compound in the pressure-sensitive adhesive layer segregates at an interface between the pressure-sensitive adhesive layer and the optical film (polarizing film), or shifts into the optical film (polarizing film), so that the pressure-sensitive adhesive layer becomes large in surface resistance value. Consequently, the pressure-sensitive adhesive layer is remarkably deteriorated in antistatic function. It has been understood that this deterioration of the pressure-sensitive adhesive layer in antistatic function causes the generation of static electricity unevenness or malfunctions of liquid crystal display devices with touch sensing functions.

An object of the present invention is to provide a liquid crystal panel with touch sensing function in which an optical film is bonded through a pressure-sensitive adhesive layer containing an ionic compound to a viewing side of a liquid crystal cell incorporated with touch sensing function, this liquid crystal panel being able to satisfy a stable antistatic function even in a humidity environment. Another object thereof is to provide a liquid crystal display device using this liquid crystal panel.

### Means for Solving the Problems

In order to solve the above-mentioned problems, the inventors have found out that a liquid crystal panel described below, with touch sensing function, can solve the problems. Thus, the present invention has been accomplished.

Accordingly, the present invention relates to:

a liquid crystal panel incorporated with touch sensing function, comprising:

a liquid crystal cell incorporated with touch sensing function, having a liquid crystal layer and a touch sensor section;

a first polarizing film arranged on a viewing side of the liquid crystal cell and a second polarizing film arranged on a side of the liquid crystal cell that is opposite to the viewing side; and

a first pressure-sensitive adhesive layer arranged between the first polarizing film and the liquid crystal cell,

wherein the first pressure-sensitive adhesive layer comprises

a pressure-sensitive-adhesive composition comprising a (meth) acrylic polymer (A) comprising, as monomer units thereof, an alkyl (meth) acrylate (a1) and an amide-group-containing monomer (a2), and an ionic compound (B), and

the first pressure-sensitive adhesive layer satisfies the following: “the variation ratio (b/a) of the surface resistance value thereof” ≤5 wherein the symbol “a” represents the surface resistance value of the first pressure-sensitive adhesive layer at the time of producing the pressure-sensitive adhesive layer attached first polarizing film in a state that the first pressure-sensitive adhesive layer is laid on the first polarizing film and further a separator is disposed on the first pressure-sensitive adhesive layer, and peeling off the separator immediately after the production; and the symbol “b” represents the surface resistance value of the first pressure-sensitive adhesive layer at the time of putting the pressure-sensitive adhesive layer attached first polarizing film in a humidity environment of 60° C. and 95%RH for 250 hours, drying the pressure-sensitive adhesive layer attached first polarizing film at 40° C. for 1 hour, and subsequently peeling off the separator.

In the liquid crystal panel incorporated with touch sensing function, the amide-group-containing monomer (a2) is preferably an N-vinyl-group-containing lactam monomer.

In the liquid crystal panel incorporated with touch sensing function, it is preferred that the amide-group-containing monomer (a2) is comprised, as a monomer unit, in the (meth) acrylic polymer (A) in a proportion of 0.1% or more by weight.

In the liquid crystal panel incorporated with touch sensing function, the ionic compound (B) is preferably an alkali metal salt. It is preferred that the ionic compound (B) is comprised in an amount of 0.01 part or more by weight for 100 parts by weight of the (meth) acrylic polymer (A).

In the liquid crystal panel incorporated with touch sensing function, it is preferred that the touch sensor section directly contacts the first pressure-sensitive adhesive layer.

The present invention relates to a liquid crystal display device comprising the above-defined liquid crystal panel incorporated with touch sensing function.

### Effect of the Invention

In the panel of the present invention incorporated with touch sensing function, a first pressure-sensitive adhesive layer is laid between a liquid crystal cell comprising a touch sensor section, and a first polarizing film arranged on the viewing side of the liquid crystal cell, and this first pressure-sensitive adhesive layer comprises a pressure-sensitive-adhesive composition comprising a (meth) acrylic polymer (A) comprising, as a monomer unit thereof, an amide-group-containing monomer (a2), and an ionic compound (B). The first pressure-sensitive adhesive layer comprises therein the ionic compound (B). In this way, the first pressure-sensitive adhesive layer can be lowered in surface resistance value to restrain the generation of static electricity.

Furthermore, in the first pressure-sensitive adhesive layer, the amide group is present which has boon introduced to side chains of the (meth) acrylic polymer (A), which is a base polymer. The presence of the amide group allows to restrain the matter that even in a humidity environment, the surface resistance value of the first pressure-sensitive adhesive layer, which is adjusted by the incorporation of the ionic compound (B), is varied to become large. Thus, the surface resistance value can be kept in a range of desired values. The presence of the amide group, which has been introduced, as a functional group of a copolymerizable monomer, into the side chains in the (meth) acrylic polymer (A), would heighten the compatibility between the (meth) acrylic polymer (A) and the ionic compound (B). As a result, even in a humidity environment, the ionic compound (B) in the first pressure-sensitive adhesive layer would be restrained from segregating or shifting to the interface between the first pressure-sensitive adhesive layer and the polarizing film or the like. Consequently, the first pressure-sensitive adhesive layer would be able to keep the surface resistance value thereof in a range of desired values. The liquid crystal panel of the present invention with touch sensing function, which has the above-mentioned first pressure-sensitive adhesive layer, would allow to restrain unevenness based en the generation of static electricity, and the generation of malfunctions, and restrain the touch panel from being lowered in sensitivity. The liquid crystal panel of the present, invention with touch sensing function is suitable, particularly, for the case of using an in-cell liquid crystal cell or an on-cell liquid crystal cell as a liquid crystal panel incorporated with touch sensing function.

Furthermore, in the pressure-sensitive adhesive layer, the amide group is present, which has been introduced to the side chains in the (meth) acrylic polymer (A) as a base polymer. The presence makes the pressure-sensitive adhesive layer good in endurance against each of glass and a transparent conductive layer (such as an ITO layer), and allows to restrain the pressure-sensitive adhesive layer, in the state of being bonded to a liquid crystal panel, from being peeled off or raised up or from undergoing other inconveniences. Moreover, the pressure-sensitive adhesive layer can satisfy endurance also in a humidity environment (after a humidity reliability test).

### BRIEF DESCRIPTION OF THE DRAWINGS

FIG. 1 is a sectional view illustrating an example of the liquid crystal panel of the present invention with touch sensing function.

FIG. 2 is a sectional view illustrating an example of the liquid crystal panel of the present invention with touch sensing function.

FIG. 3 is a sectional view illustrating an example of the liquid crystal panel of the present invention with touch sensing function.

### MODE FOR CARRYING OUT THE INVENTION

The liquid crystal panel of the present invention incorporated with touch sensing function will be described with reference to the drawings. The liquid crystal panel of the invention incorporated with touch sensing function has a liquid crystal cell C having a liquid crystal layer 3 and a touch sensor section 5, a first polarizing film 11 arranged on a viewing side of the liquid crystal cell C, a second polarizing film 12 arranged on a side thereof that is opposite to the viewing side, and a first pressure-sensitive adhesive layer 21 arranged between the first polarizing film 11 and the liquid crystal cell C. The above-mentioned individual constituents of the liquid crystal panel of the invention incorporated with touch sensing function can be shown as follows from the viewing side: first polarizing film 11/first pressure-sensitive adhesive layer 21/liquid crystal cell C/second polarizing film 12. In the liquid crystal panel incorporated with touch sensing function, the order of the individual constituents has been briefly shown. However, a different constituent may be appropriately located between any two of the constituents.

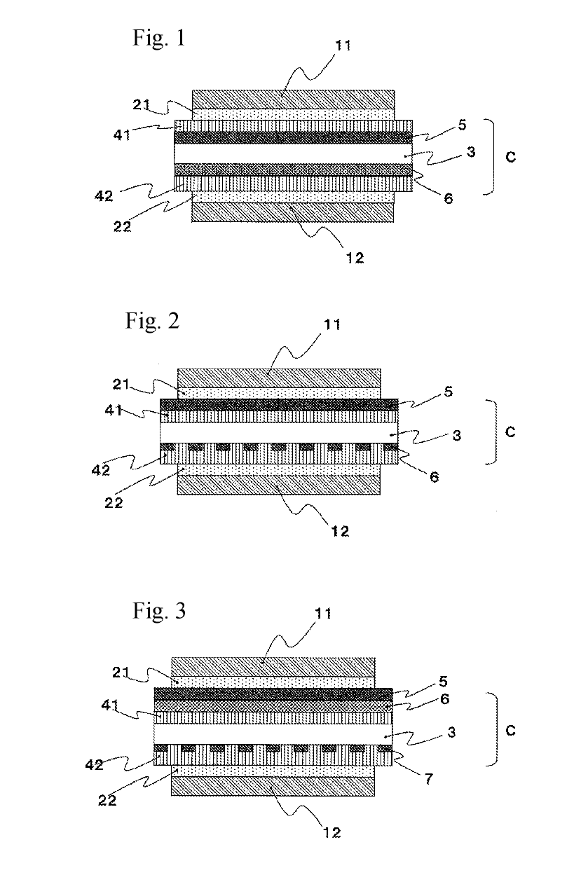

A specific example of the liquid crystal panel of the present invention incorporated with touch sensing function is illustrated in, for example, each of FIGS. 1 to 3.

FIG. 1 is one of the so-called in-cell liquid crystal panels incorporated with touch sensing function, and the panel has, from a viewing side thereof, a structure of first polarizing film 11/first pressure-sensitive adhesive layer 21/first transparent substrate 41/touch sensor section 5/liquid crystal layer 3/driving-electrode-concurrently-functioning sensor section 6/second transparent substrate 42/second pressure-sensitive adhesive layer 22/second polarizing film 12. In the in-cell liquid crystal panel incorporated with touch sensing function in FIG. 1, for example, the liquid crystal cell C has the touch sensor section 5 and the driving-electrode-concurrently-functioning sensor section 6 inside the first and second glass substrates 41 and 42 (inside the liquid crystal cell) sandwiching the liquid crystal layer 3 therebetween.

FIG. 2 is a modified example of one of the so-called in-cell (semi-in-cell) liquid crystal panels incorporated with touch sensing function, and the panel has, from a viewing side thereof, a structure of first polarizing film 11/first pressure-sensitive adhesive layer 21/touch sensor section 5/first transparent substrate 41/liquid crystal layer 3/driving-electrode-concurrently-functioning sensor section 6/second transparent substrate 42/second pressure-sensitive adhesive layer 22/second polarizing film 12. About the in-cell liquid crystal panel incorporated with touch sensing function in FIG. 2, for example, in the liquid crystal cell C, the touch sensor section 5 directly contacts the first, pressure-sensitive adhesive layer 21 outside the first transparent substrate 41. The liquid crystal cell C has the driving-electrode-concurrently-functioning sensor section 6 on the second transparent substrate 42 side of the inside of the first, and second glass substrates 41 and 42 (the inside of the liquid crystal cell) sandwiching the liquid crystal layer 3 therebetween.

FIG. 3 is one of the so-called on-cell liquid crystal panels incorporated with touch sensing function, and the panel has, from a viewing side thereof, a structure of first-polarizing film 11/first pressure-sensitive adhesive layer 21/touch sensor section 5/driving-electrode-concurrently-functioning sensor section 6/first transparent substrate 41/liquid crystal layer 3/driving electrode 7/second transparent substrate 42/second pressure-sensitive adhesive layer 22/second polarizing film 12. In the on-cell liquid crystal panel incorporated with touch sensing function in FIG. 3, for example, the liquid crystal cell C has the touch sensor section 5 and the driving-electrode-concurrently-functioning sensor section 6 outside the first transparent substrate 41. The touch sensor section 5 directly contacts the first pressure-sensitive adhesive layer 21, and has the driving electrode 7 on the second transparent substrate 42 side of the inside of the first and second glass substrates 41 and 42 (the inside of the liquid crystal cell) sandwiching the liquid crystal layer 3 therebetween.

When the touch sensor section 5 of the liquid crystal cell C directly contacts the first pressure-sensitive adhesive layer 21 in the liquid crystal panel incorporated with touch sensing function, the (ionic-compound-containing) first pressure-sensitive adhesive layer 21 is easily lowered in antistatic function, in particular, in a humidity environment. Accordingly, the liquid crystal panel of the present invention incorporated with touch sensing function is applied favorably to, out of the illustrated examples, the in-cell liquid crystal panel incorporated with touch sensing function (modified example) illustrated in FIG. 2 or the on-cell liquid crystal panel incorporated with touch sensing function illustrated in FIG. 3.

The first polarizing film 11 and the second polarizing film 12 are each generally a polarizing film in which a polarizer has, on a single surface or both surfaces thereof, a transparent protective film. The first polarizing film 11 and the second polarizing film 12 are located, respectively, on both sides of the liquid crystal layer 3 to cause their transmission axes for absorption axes) to cross each other.

The polarizer is not particularly limited, and may be a polarizer that may be of various types. Examples of the polarizer include a product yielded by causing a dichronic substance, such as iodine or a dichronic dye, to be adsorbed onto a hydrophilic polymer film, such as a polyvinyl alcohol based film, a partially formylated polyvinyl alcohol based film or an ethylene/vinyl acetate copolymer based partially-saponified film, and then stretching the resultant uniaxially; and a polyene based aligned film made of, for example, a polyvinyl-alcohol-dehydrated product or a polyvinyl-chloride-dehydrochloride-treated product. Out of such polarizers, preferred is a polarizer composed of a polyvinyl alcohol based film and a dichronic substance such as iodine. The thickness of these polarizers is not particularly limited, but generally about 80 μm or less.

The polarizer may be a thin polarizer having a thickness of 10 μm or less. From the viewpoint of making the liquid crystal panel thinner, the thickness is preferably from 1 to 7 μm. Such a thin polarizer is favorable in that the polarizer is thin in thickness unevenness, excellent in viewability, and is small in dimension change to be excellent in endurance, and further makes the resultant polarizing film thin in thickness.

The material for forming the transparent protective film(s) is, for example, a thermoplastic resin excellent in transparency, mechanical strength, thermal stability, water blocking performance, isotropy, and others. Specific examples of the thermoplastic resin include cellulose resins such as triacetylcellulose, polyester resins, polyethersulfone resins, polysulfone resins, polycarbonate resins, polyamide resins, polyimide resins, polyolefin resins, (meth) acrylic resins, cyclic polyolefin resins (norbornene resins), polyarylate resins, polystyrene resins, and polyvinyl alcohol resins; and mixtures of two or more of these resins. Onto one of the two sides of the polarizer is bonded the transparent protective film through an adhesive layer. For the transparent protective film on the other side, the following may be used: a thermosetting or ultraviolet curable resin such as a (meth) acrylic, urethane, acrylurethane, epoxy or silicone resin.

Since the first pressure-sensitive adhesive layer laid on the transparent protective film can be controlled to be made small in variation ratio (b/a) of the surface resistance value, the material of the transparent, protective film is preferably a cellulose resin or a (meth) acrylic resin. A (meth) acrylic resin is particularly preferred since the resin allows to control, into a smaller value, the variation ratio (b/a) of the surface resistance value of the first pressure-sensitive adhesive layer than any cellulose resin. The (meth) acrylic resin is preferably a (meth) acrylic resin having a lactone ring structure. The (meth) acrylic resin having a lactone ring structure is, for example, a (meth) acrylic resin having a lactone ring structure described in, for example, JP-A-2000-230016, JP-A-2001-151814, JP-A-2002-120326, JP-A-2002-254544 or JP-A-2005-146084.

A functional layer may be laid onto the surface of the transparent protective film onto which the polarizer is not bonded, examples of the layer including a hard coat, layer, an anti-reflection layer, a sticking preventing layer, a diffusion layer and an anti-glare layer.

The adhesive used to bond the: polarizer and the transparent protective film to each other is not particularly limited as far as the adhesive is optically transparent. The adhesive may be in various forms or of various types, such as water-based, solvent-based, hot-melt, radical curable, and cation curable forms or types. The adhesive is preferably a water-based or radical curable adhesive.

About the first polarizing film 11 arranged on the viewing side of the liquid crystal cell C and the second polarizing film 12 arranged on the side thereof that is opposite to the viewing side, any other optical film may be laminated onto each of these polarizing films in accordance with the suitability of the arrangement position of the polarizing film. The other optical film may be a film that is to be an optical layer which may be used to form, for example, a liquid crystal display device, examples of this film including a reflector, a transreflector, a retardation film (such as a half or quarter wavelength plate, or any other wavelength plate), a viewing angle compensation film, and a brightness enhancement film. One or more of these films are usable in the form of one or two or more layers. Also when one or more of these other optical films are used, the pressure-sensitive adhesive layer nearest to the liquid crystal layer 3 is preferably rendered the first pressure-sensitive adhesive layer 21.

The first, pressure-sensitive adhesive layer 21 is formed to include a pressure-sensitive-adhesive, composition, including a (meth) acrylic polymer (A) comprising, as monomer units thereof, an alkyl (meth) acrylate (a1) and an amide-group-containing monomer (a2), and an ionic compound (B). The pressure-sensitive-adhesive composition will be described in detail later.

The second pressure-sensitive adhesive layer 22 is made of a pressure-sensitive adhesive. The pressure-sensitive adhesive may be a pressure-sensitive adhesive that may be of various types. Examples thereof include rubbery, acrylic, silicone, urethane, vinyl alkyl ether, polyvinylpyrrolidone, polyacrylamide, and cellulose type pressure-sensitive adhesives. In accordance with the kind of the pressure-sensitive adhesive, a base polymer having pressure-sensitive adhesive property is selected. Out of the above-mentioned pressure-sensitive adhesives, an acrylic pressure-sensitive adhesive is preferably used since the pressure-sensitive adhesive is excellent in optical transparency, shows pressure-sensitive adhesive properties of appropriate wettability, cohesive property and adhesiveness, and is excellent in weather resistance, heat resistance and others. The thickness of the second pressure-sensitive adhesive layer 22 is hot particularly limited, and is, for example, from about 1 to 100 μm. The thickness is preferably from 2 to 50 μm, more preferably from 2 to 40 μm, even more preferably from 5 to 35 μm.

The liquid crystal layer 3 which the liquid crystal cell C has may be a liquid crystal layer that is applied to a liquid crystal panel incorporated with touch sensing function, and contains liquid crystal molecules aligned homogeneously in the state of receiving no electric field. The liquid crystal layer 3 is preferably, for example, a liquid crystal layer in an IPS mode. As the liquid crystal layer 3, a liquid crystal layer of any type is usable, examples of the type including TN, STN, n type, and VA types. The thickness of the liquid crystal layer is, for example, from about 1.5 to 4 μm.

In the liquid crystal cell C, the first and second transparent substrates 41 and 42 sandwich the liquid crystal layer 3 therebetween; thus, a liquid crystal cell can be formed. Inside or outside of the liquid crystal cell, the touch sensor section 5, the driving-electrode-concurrently-functioning sensor section 6, the driving electrode 7 and others can be formed in accordance with the form of the liquid crystal panel incorporated with touch sensing function. Furthermore, a color, filter substrate can be disposed on the liquid crystal cell (first transparent substrate 41).

The material which forms each of the transparent substrates may be, for example, a glass piece or a polymer film. For the polymer film, for example, the following polymer can be given: polyethylene terephthalate, polycycloolefin, or polycarbonate. When the transparent substrate is made of glass, the thickness thereof is, for example, from about 0.3 to 1 mm. When the transparent substrate is a polymer film, the thickness thereof is, for example, from about 10 to 200 μm. The transparent substrate may have, on a surface thereof, an easily bonding layer or a hard coat layer.

The touch sensor section 5 (capacitive sensor), the driving-electrode-concurrently-functioning sensor section 6, and the driving electrode 7 are each formed in the form of a transparent conductive layer. The constituting material of the transparent conductive layer is not particularly limited. Examples thereof include metals such as gold, silver, copper, platinum, palladium, aluminum, nickel, chromium, titanium, iron, cobalt, tin, magnesium, and tungsten; and alloys of two or more of these metals. Other examples of the constituting material of the transparent conductive layer include metal oxides of indium, tin, zinc, gallium, antimony, zirconium, and cadmium. Specific examples thereof include indium oxide, tin oxide, titanium oxide, and cadmium oxide; and mixtures of two or more of these oxides. Additional examples thereof include other metal compounds such as copper iodide. As the need arises, the above-mentioned metal oxides may each further contain an oxide of any one of the metal atoms described in the above-mentioned group. The constituting material is preferably, for example, an indium oxide containing tin oxide ITO), or a tin oxide containing antimony, in particular preferably ITO. The compound ITO preferably contains 80 to 99% by weight of indium oxide and 1 to 20% by weight of tin oxide.

The position of the liquid crystal cell C where the touch sensor layer 5 is formed is not particularly limited. Thus, the touch sensor layer 5 is formed in accordance with the form of the liquid crystal panel incorporated with touch sensing function. For example, in each of FIGS. 1 to 3, a case is illustrated in which the touch sensor layer 5 is located between the first polarizing film 11 and the liquid crystal layer 3. The touch sensor layer 5 may be formed in the form of, e.g., a transparent electrode pattern on the first transparent substrate 41. Also about each of the driving-electrode-concurrently-functioning sensor section 6 and the driving electrode 7, using a usual way, a transparent electrode pattern can be formed in accordance with the form of the liquid crystal panel incorporated with touch sensing function. The transparent electrode pattern is usually connected electrically to a leading-in wire (not illustrated) formed at an end of the transparent substrate, and the leading-in wire is connected to a controller IC (not illustrated). The shape of the transparent electrode pattern may a comb shape, a stripe shape, a rhomboid shape or any other shape in accordance with the usage thereof. The height of the transparent electrode pattern is, for example, from 10 to 100 nm, and the width thereof is from 0.1 to 5 mm.

In the liquid crystal panel incorporated with touch sensing function, a member for forming a liquid crystal display device is usable, examples thereof including a backlight or a reflector as a lighting system.

Hereinafter, a description will be made about the pressure-sensitive-adhesive composition which forms the first pressure-sensitive adhesive layer 21. The pressure-sensitive-adhesive composition includes a (meth) acrylic polymer (A) including an alkyl (meth) acrylate (a1) and an amide-group-containing monomer (a2), and an ionic compound (B). The wording “(meth) acrylate” denotes acrylate and/or methacrylate. In the present invention, the expression “(meth)a” has substantially the same meanings.

The (meth) acrylic polymer (A) contains, as a main component thereof, the alkyl (meth) acrylate (a1) as a monomer unit. The alkyl (meth) acrylate, which constitutes a main skeleton of the (meth) acrylic polymer (A), is, for example, a (meth) acrylate having a linear or branched alkyl group having 1 to 18 carbon atoms. Examples of the alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These groups may be used singly or in combination. The average number of carbon atoms in each of these alkyl groups is preferably from 3 to 9.

The proportion by weight of the alkyl (meth) acrylate (a1) is preferably 70% or more by weight of all constituting monomers (proportion thereof: 100% by weight), as monomer units, that constitute the (meth) acrylic polymer (A). The proportion by weight of the alkyl (meth) acrylate (a1) can be regarded as that of the rest of the polymer that is other than the amide-group-containing monomer (a2) and other copolymerizable monomers. By setting the proportion by weight of the alkyl (meth) acrylate (a1) into the above-mentioned range, the pressure-sensitive-adhesive composition favorably ensures adhesiveness.

The amide-group-containing monomer (a2) is a compound containing, in the structure thereof, an amide group, and a polymerizable unsaturated double bond in, e.g., a (meth) acryloyl group or a vinyl group. Specific examples of the amide-group-containing monomer (a2) include (meth) acrylamide, N,N-dimethyl (meth) acrylamide, N,N-diethyl (meth) acrylamide, N-isopropylacrylamide, N-methyl (meth) acrylamide, N-butyl (meth) acrylamide, N-hexyl (meth) acrylamide, N-methylol (meth) acrylamide, N-methylol-N-propane (meth) acrylamide, aminomethyl (meth) acrylamide, aminoethyl (meth) acrylamide, mercaptomethyl (meth) acrylamide, mercaptoethyl (meth) acrylamide and other acrylamide monomers; N-(meth) acryloylmorpholine, N-(meth) acryloylpiperidine, N-(meth) acryloylpyrrolidine, and other acryloyl heterocyclic monomers; and N-vinylpyrrolidone, N-vinyl-ε-caprolactam, and other N-vinyl-containing lactam monomers. The amide-group-containing monomer (a2) is favorable for restraining a rise in surface resistance value with time (particularly in a humidity environment) and causing the layer to satisfy endurance. Out of such amide-group-containing monomers (a2), N-vinyl-group-containing lactam monomers are particularly preferred for restraining a rise of the layer in surface resistance value with time (particularly in a humidity environment) and causing the layer to satisfy endurance against the transparent conductive layer (touch sensor layer). It is preferred not to use any amide-group-containing monomer having a hydroxy group, examples thereof not being given above, since a combination thereof with the ionic compound (B) tends to raise the pressure-sensitive adhesive layer in electroconductivity. Moreover, when the use proportion thereof is increased, problems are caused about an anchor power thereof to the polarizing film (optical film) or the re-workability thereof to the transparent conductive layer (touch sensor layer).

The proportion by weight of the amide-group-containing monomer (a2) is preferably 0.1% or more by weight of the above-mentioned monomer components to restrain a rise of the layer in surface resistance value with time (particularly in a humidity environment). The proportion by weight is preferably 0.3% or more by weight, more preferably 0.5% or more by weight. If the proportion by weight becomes too large, the anchor power of the pressure-sensitive adhesive layer to the polarizing film or some other substrate film tends to be lowered. Thus, the proportion by weight is preferably 35% or less by weight, more preferably 30% or less by weight, even more preferably 25% or less by weight.

Besides the above-mentioned monomer units, the following may be introduced into the (meth) acrylic polymer (A) by copolymerization to improve the pressure-sensitive adhesive layer in adhesiveness and heat, resistance: one or more copolymerizable monomers each having a polymerizable functional group having an unsaturated double bond, such as a (meth) acryloyl group or a vinyl group.

The copolymerizable monomer (s) may (each) be, for example, an aromatic-ring-containing (meth) acrylate. The aromatic-ring-containing (meth) acrylate is a compound containing, in the structure thereof, an aromatic ring structure and a (meth) acryloyl group. Examples of the aromatic ring include benzene, naphthalene and biphenyl rings.

Specific examples of the aromatic-ring-containing (meth) acrylate include benzyl (meth) acrylate, phenyl (meth) acrylate, o-phenylphenol (meth) acrylate phenoxy (meth) acrylate, phenoxyethyl (meth) acrylate, phenoxypropyl (meth) acrylate, phenoxydiethylene glycol (meth) acrylate, ethylene-oxide-modified nonylphenol (meth) acrylate, ethylene-oxide-modified cresol (meth) acrylate, phenol-ethylene-oxide-modified (meth) acrylate, 2-hydroxy-3-phenoxypropyl (meth) acrylate, methoxybenzyl (meth) acrylate, chlorobenzyl (meth) acrylate, cresyl (meth) acrylate, polystyryl (meth) acrylate, and other (meth) acrylates each having a benzene ring; hydroxyethylated-β-naphthol acrylate, 2-naphthylethyl (meth) acrylate, 2-naphthoxyethyl acrylate, 2-(4-methoxy-1-naphthoxy) ethyl (meth) acrylate, and other (meth) acrylates each having a naphthalene ring; and biphenyl (meth) acrylate, and other (meth) acrylates each having a biphenyl ring.

The aromatic-ring-containing (meth) acrylate is preferably benzyl (meth) acrylate, or phenoxyethyl (meth) acrylate, in particular preferably phenoxyethyl (meth) acrylate from the viewpoint of adhesive properties and the endurance of the first pressure-sensitive adhesive layer.

The proportion by weight of the aromatic-ring-containing (meth) acrylate is preferably 25% or less by weight, more preferably from 3 to 25% by weight, even more preferably from 8 to 22% by weight, even more preferably from 12 to 18% by weight of the above-mentioned monomer components. When the proportion by weight of the aromatic-ring-containing (meth) acrylate is 3% or more by weight, a display unevenness of the panel is favorably restrained. If the proportion by weight is more than 25% by weight, the restraint of the display unevenness is contrarily insufficient so that the endurance tends to be lowered.

Furthermore, the copolymerizable monomer(s) may (each) be a carboxyl-group-containing monomer, and a hydroxyl-group-containing monomer.

The carboxyl-group-containing monomer is a compound containing, in the structure thereof, a carboxyl group and a polymerizable unsaturated double bond in, e.g., a (meth) acryloyl group or a vinyl group. Specific examples of the carboxyl-group-containing monomer include (meth) acrylic acid, carboxyethyl (meth) acrylate, carboxypentyl (meth) acrylate, itaconic acid, maleic acid, fumaric acid, and crotonic acid. Out of such carboxyl-group-containing monomers, acrylic acid is preferred from the viewpoint of the copolymerizability, the price and adhesive properties thereof.

The hydroxyl-group-containing monomer is a compound containing, in the structure thereof, a hydroxyl group and a polymerizable unsaturated double bond, e.g., a (meth) acryloyl group or a vinyl group. Specific examples of the hydroxyl-group-containing monomer include 2-hydroxyethyl (meth) acrylate, 3-hydroxypropyl (meth) acrylate, 4-hydroxybutyl (meth) acrylate, 6-hydroxyhexyl (meth) acrylate, 8-hydroxyoctyl (meth) acrylate, 10-hydroxydecyl (meth) acrylate, 12-hydroxylauryl (meth) acrylate, and other hydroxyalkyl (meth) acrylates; and (4-hydroxymethylcyclohexyl)-methyl acrylate. Out of such hydroxyl-group-containing monomers, preferred are 2-hydroxyethyl (meth) acrylate, 4-hydroxybutyl (meth) acrylate, and particularly preferred is 4-hydroxybuyl (meth) acrylate from the viewpoint of the endurance of the resultant.

When the pressure-sensitive-adhesive composition contains a crosslinking agent, the carboxyl-group-containing monomer and the hydroxyl-group-containing monomer each become a reaction point with the crosslinking agent. The carboxyl-group-containing monomer and the hydroxyl-group-containing monomer are rich in reactivity with an intermolecular crosslinking agent. Thus, these monomers are preferably used to improve the resultant pressure-sensitive adhesive layer in cohesive property and heat resistance. The carboxyl-group-containing monomer is favorable since the resultant layer is made consistent between endurance and re-workability, and the hydroxyl-group-containing monomer is favorable because of the re-workability of the resultant.

The proportion by weight of the carboxyl-group-containing monomer is preferably 2% or less by weight, more preferably from 0.01 to 2% by weight, even more preferably from 0.05 to 1.5% by weight, even more preferably from 0.1 to 1% by weight, most preferably from 0.1 to 0.5% by weight of the above-mentioned monomer components. From the viewpoint of the endurance of the resultant, it is preferred to set the proportion by weight of the carboxyl-group-containing monomer to 0.01% or more by weight. From the viewpoint of the re-workability thereof, it is not preferred that the proportion by weight is more than 2% by weight.

The proportion by weight of the hydroxyl-group-containing monomer is preferably 3% or less by weight, more preferably from 0.01 to 3% by weight, even more preferably from 0.1 to 2% by weight, even more preferably from 0.2 to 2% by weight of the above-mentioned monomer components. For the cross linking of the pressure-sensitive adhesive layer, and the endurance and adhesive properties thereof, it is preferred to set the proportion by weight of the hydroxyl-group-containing monomer to 0.01% or more by weight. For the endurance of the layer, it is not preferred that the proportion by weight is more than 3% by weight.

Specific examples of the copolymer monomer (s) that are other than the above-mentioned examples include acid-anhydride-group-containing monomers such as maleic anhydride, and itaconic anhydride; caprolactone adducts of acrylic acid; sulfonic-acid-group-containing monomers such as allylsulfonic acid, 2-(meth) acrylamide-2-methylpropanesulfonic acid, (meth) acrylamidepropanesulfonic acid, and sulfopropyl (meth) acrylate; and phosphoric-acid-group-containing monomers such as 2-hydroxyethylacryloyl phosphate.

Examples of the monomer(s) for modifying the pressure-sensitive-adhesive composition also include alkylaminoalkyl (meth) acrylates such as aminoethyl (meth) acrylate, N,N-dimethylaminoethyl (meth) acrylate, t-butylaminoethyl (meth) acrylate; alkoxyalkyl (meth) acrylates such as methoxyethyl (meth) acrylate, ethoxyethyl (meth) acrylate; succinimide-based monomers such as N-(meth) acryloyloxymethylene succinimide, N-(meth) acryloyl-6-oxyhexamethylene succinimide, and N-(meth) acryloyl-8-oxyoctamethylene succinimide; maleimide-based monomers such as N-cyclohexylmaleimide and N-isopropylmaleimide, N-laurylmaleimide and N-phenylmaleimide; and itaconimide-based monomers such as N-methylitaconimide, N-ethylitaconimide, N-butylitaconimide, N-octylitaconimide, N-2-ethylhexylitaconimide, N-cyclohexylitaconimide, and N-lanrylitaconimide.

Additional examples usable as the modifying monomer(s) include vinyl monomers such as vinyl acetate, and vinyl propionate; cyanoacrylate monomers such as acrylonitrile, and methacrylonitrile; epoxy-group-containing (meth) acrylates such as glycidyl (meth) acrylate; glycol (meth) acrylates such as polyethylene glycol (meth) acrylate, polypropylene glycol (meth) acrylate, methoxyethylene glycol (meth) acrylate, and methoxypolypropylene glycol (meth) acrylate; and other (meth) acrylate monomers such as tetrahydrofurfuryl (meth) acrylate, fluorine (meth) acrylate, silicone (meth) acrylate, and 2-methoxyethyl acrylate. Other examples thereof include isoprene, butadiene, isobutylene, and vinyl ether.

Different examples of the copolymerizable monomer (s) that is other than the above-mentioned/examples include silane monomers each containing a silicon atom. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such, as (meth) acryloyl groups or vinyl groups, which include (meth) acrylate esters of polyhydric alcohols, such as tripropylene glycol di (meth) acrylate, tetraethylene glycol di (meth) acrylate, 1,6-hexanediol di (meth) acrylate, bisphenol A diglycidyl ether di (meth) acrylate, neopentyl glycol di (meth) acrylate, trimethylolpropane tri (meth) acrylate, pentaerythritol tri (meth) acrylate, pentaerythritol tetra (meth) acrylate, dipentaerythritol penta (meth) acrylate, dipentaerythritol hexa (meth) acrylate, and caprolactone-modified dipentaerythritol hexa (meth) acrylate; and compounds having a polyester, epoxy or urethane skeleton to which two or more unsaturated double bonds are added in the form of functional groups such as (meth) acryloyl groups or vinyl groups in the same manner as the monomer component, such as polyester (meth) acrylates, epoxy (meth) acrylates and urethane (meth) acrylates.

About the proportion of the other copolymerizable monomers in the (meth)acrylic polymer (A), the proportion by weight thereof is preferably from about 0 to 10%, more preferably from about 0 to 7%, even more preferably from about 0 to 5% by weight of all the constituting monomers (100% by weight).

In the present invention, the weight-average molecular weight of the (meth) acrylic polymer (A) is preferably from 1000000 to 2500000. Considering the endurance of the pressure-sensitive adhesive layer, particularly, the heat resistance thereof, the weight-average molecular weight is preferably from 1200000 to 2000000. From the viewpoint of the heat resistance, it is preferred that the weight-average molecular weight is 1000000 or more. If the weight-average molecular weight becomes more than 2500000, the pressure-sensitive adhesive tends to become hard easily so that the adherend is easily peeled off. The ratio of the weight-average molecular weight (Mw)/the number-average molecular weight (Mn), which shows the molecular weight distribution of the polymer (A), is preferably from 1.8 to 10 both inclusive, more preferably from 1.8 to 7, even more preferably from 1.8 to 5. If the molecular weight distribution (Mw/Mn ratio) is more than 10, the polymer (A) is unfavorable from the viewpoint of the endurance of the pressure-sensitive adhesive layer. The weight-average molecular weight and the molecular weight distribution (Mw/Mn ratio) are gained from values obtained by measuring the polymer by GPC (gel permeation chromatography) and applying, to the measured value, a calculation in terms of polystyrene.

For the production of the (meth) acrylic polymer (A), a known producing method is appropriately selectable, examples thereof including solution polymerization, bulk polymerization, emulsion polymerization, and various radical polymerizations. The obtained (meth) acrylic polymer (A) may be any one of a random copolymer, a block copolymer, a graft copolymer, and others.

In the solution polymerization, as a polymerizing solvent, for example, ethyl acetate or toluene is used. In a specific example of the solution polymerization, a reaction therefor is conducted in the presence of an added polymerization initiator under the flow of an inert gas such as nitrogen ordinarily under conditions of a temperature of about 50 to 70° C. and a period of about 5 to 30 hours.

The polymerization initiator, a chain transfer agent, an emulsifier and others that are used in each of the radical polymerizations are not particularly limited, and are appropriately selectable to be used. The weight-average molecular weight of the (meth) acrylic polymer (A) is controllable in accordance with the use amounts of the polymerization initiator and the chain transfer agent, and conditions for the reaction. Correspondingly to the kinds of these components, the use amounts thereof are appropriately adjusted.

The pressure-sensitive adhesive composition of the present invention includes an ionic compound (B) The ionic compound (B) is preferably an alkali metal salt and/or an organic cation-anion salt. The alkali metal salt may be an organic salt and an inorganic salt of an alkali metal. The “organic cation-anion salt” referred to in the present invention denotes an organic salt having a cation moiety made of an organic substance. Its anion moiety may be an organic substance or an inorganic substance. The “organic cation-anion salt” may also be called an ionic liquid or an ionic solid.

### <Alkali Metal Salt>

Examples of an alkali metal ion included in the cation moiety of the alkali metal salt include respective ions of lithium, sodium and potassium. Out of these alkali metal ions, a lithium ion is preferred.

The anion moiety of the alkali metal salt may be made of an organic substance or an inorganic substance. The anion moiety included in an organic salt may be, for example, CH₃COO⁻, CF₃COO⁻, CH₃SO₃⁻, CF₃SO₃⁻, (CF₃SO₂)₃C⁻, C₄F₉SO₃⁻, C₃F₇COO⁻, (CF₃SO₂) (CF₃CO) N⁻, ⁻O₃S(CF₂)₃SO₃⁻, PF₆⁻, CO₃²⁻², or an anion moiety

represented: by any one of the following general formulae (1) to (4):

(1): (CₙF₂ₙ₊₁SO₂)₂N⁻ wherein n is an integer from 1 to 10,

(2): CF₂(CₘF₂ₘSO₂) wherein m is an integer from 1 to 10,

(3): ⁻O₃S(CF₂)₁SO₃⁻ wherein 1 is an integer from 1 to 10, and

(4): (CₚF₂ₚ₊₁SO₂) N⁻ (C_{q}F_{2g+1}SO₂) wherein p and q are each an integer from 1 to 10.

Particularly preferred is an anion moiety containing a fluorine atom since the moiety gives an ionic compound good in ion dissociation. The anion moiety included in the inorganic salt is, for example, Cl⁻, Br⁻, I⁻, AlCl₄⁻, Al₂Cl₇⁻, BF₄⁻, PF₆⁻, ClC₄⁻, NO₃⁻, ASF₆⁻, SbF₆⁻, NbF₆⁻, TaF₆⁻, or (CN)₂N⁻. The anion moiety is preferably (CF₃SO₂)₂N⁻, (C₂F₅SO₂)₂N⁻, or any other (perfluoroalkylsulfonyl) imide represented by the above-mentioned general formula (1), in particular preferably (trifluoromethanesulfonyl) imide, which is represented by (CF₃SO₂)₂N⁻.

Specific examples of the organic salt of an alkali metal include sodium acetate, sodium alginate, sodium lignin sulfonate, sodium toluene sulfonate, LiCF₃SO₃, Li (CF₃SO₂)₂N, Li (CF₃SO₂)₂N, Li (C₂F₅S0₂)₂N, Li (C₄F₉SO₂)₂N, Li (CF₃SO₂)₃C, KO₃S (CF₂)₃SO₃K, LiO₃S (CF₂)₃SO₃K and others. Out of these examples, preferred are LiCF₃SO₃, Li (CF₃SO₂)₂N, Li (C₂F₅SO₂)₂N, Li (C₄F₉SO₂)₂N, Li (CF₃SO₂)₃C and others. More, preferred are fluorine-containing lithium imide salts, which are lithium salts of bis (fluerosulfonyl) imides, such as Li (CF₃SO₂)₂N, Li (C₂F₅SO₂)₂N, and Li (C₄F₉SO₂)₂N. Particularly preferred are lithium salts of (perfluoroalkylsulfonyl) imide. A different example of the organic salt is a lithium salt of 4,4,5,5-tetrafluoro-1,3,2-dithiazolidine-1,1,3,3-tetraoxide.

Examples of the inorganic salt of an alkali metal include lithium perchlorate, and lithium iodide.

<Organic Cation-Anion Salt>

The organic cation-anion salt used in the present invention is a salt composed of a cation component and an anion component in which the cation component is made of an organic substance. Specific examples of the cation component include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, and a tetraalkylphosphonium cation.

As the anion component, for example, the following is used Cl⁻, Br⁻, I⁻AlCl₄⁻, Al₂Cl₂⁻, BF₄⁻, PF₆⁻, ClO₄⁻, NO₃⁻, CH₃COO⁻, CF₃COO⁻, CH₃SO₃⁻, CF₃SO₃⁻, (CF₃SO₂)₃C⁻, AsF₆⁻, SbF₆⁻, NbF₆⁻, TaF₆⁻, (CN)₂N⁻, C₄F₉SO₃⁻, C₃F₇COO⁻, (CF₃SO₂) (CF₃CO)N⁻, ⁻O₃S(CF₂)₃SO₃⁻, or an anion moiety represented by any one of the following general formulae (1) to (4):

(1): (CₙF₂ₙ₊₁SO₂)₂N⁻ wherein n is an integer from 1 to 10,

(2): CF₂(CₘF₂ₘSO₂)₂N⁻ wherein m is an integer from 1 to 10,

(3): ⁻O₃S (CF₂)₁SO₃⁻ wherein 1 is an integer from 1 to 10, and

(4): (CₚF₂ₚ₊₁SO₂) N⁻ (C_{q}F_{2q+1}SO₂) wherein p and q are each an integer from 1 to 10. Out of these examples, particularly preferred is an anion moiety containing a fluorine atom since the moiety gives an ionic compound good in ion dissociation.

As the organic cation-anion salt, a compound is appropriately selected and used which is made of a combination of any one of the above-mentioned cation component with any one of the above-mentioned anion components. Preferred and specific examples of the organic cation-anion salt include methyltrioctylammonium bis(trifluoromethanesulfonyl) imide, 1-methyl-1-propylpyrrolidinium bis(trifluoromethanesulfonyl) imide, and ethylmethylimidazolium bis(fluorosulfonylimide). Out of these examples, more preferred are 1-methyl-1-propylpyrrolidiniumium bis (trifluoromethanesulfonyl) imide, and ethylmethylimidazolium bis (fluorosulfonyl imide).

Examples of the ionic compound (B) are following besides the above-mentioned alkali metal salts and organic cation-anion salts: ammonium chloride, aluminum chloride, copper chloride, ferrous chloride, ferric chloride, ammonium sulfate and other inorganic salts.

These ionic compounds (B) may be used singly or in any combination of two or more thereof in order that the pressure-sensitive adhesive layer may gain a desired resistance value. In order to control the surface resistance value of the pressure-sensitive adhesive layer, particularly, into the range of 1×10¹⁰ to 1×10¹² Ω/□, an alkali metal salt is preferably used as the ionic compound (B) since the salt makes the layer high in antistatic performance. The use of the alkali metal salt allows to give a pressure-sensitive adhesive high in antistatic performance even when the number of the blend parts of the salt is small. In the meantime, in order to control the surface resistance value of the pressure-sensitive adhesive layer into the range of 1×10⁸ to 1×10¹⁰ Ω/□, an organic cation-anion salt is preferably used as the ionic compound (B) since the salt makes the layer high in antistatic performance. The use of the organic cation-anion salt allows to give a pressure-sensitive adhesive high in antistatic performance even when the number of the blend parts of the salt is small.

The proportion of the ionic compound (B) in the pressure-sensitive-adhesive composition of the present-invention is appropriately adjustable to cause the pressure-sensitive adhesive layer and the touch panel to satisfy antistatic property and sensitivity, respectively. It is preferred to adjust the proportion of the ionic compound (B) in accordance with, for example, the kind of the liquid crystal panel incorporated with touch sensing function, considering the proportion by weight of the amide-group-containing monomer (a2) introduced into the (meth) acrylic polymer (A), the kind of the transparent protective film(s) for the polarizing films, and others to set the surface resistance value of the pressure-sensitive adhesive layer into range of 1.0×10⁸ to 1.0×10¹²Ω/□. For example, in the in-cell liquid crystal panel illustrated in FIG. 1, incorporated with touch sensing function, the surface resistance value of the first pressure-sensitive adhesive layer is preferably controlled into the range of 1×10⁸ to 1×10¹⁰ Ω/□. In the semi-in-cell liquid crystal panel illustrated in FIG. 2, incorporated with touch sensing function, or the on-cell liquid crystal panel in FIG. 3 with the same, the surface resistance value of the first pressure-sensitive adhesive: layer is preferably controlled into the range of 1×10¹⁰ to 1×10¹² Ω/□.

The first pressure-sensitive adhesive layer is controlled to cause the variation ratio (b/a) of the surface resistance value thereof to satisfy 5 or less. The symbol “a” represents the surface resistance value of the first pressure-sensitive adhesive layer at the time of producing the pressure-sensitive adhesive layer attached first polarizing film in a state that the first pressure-sensitive adhesive layer is laid on the first polarizing film and further a separator is disposed on the first pressure-sensitive adhesive layer, and peeling off the separator immediately after the production; and the symbol “b” represents the surface resistance value of the first pressure-sensitive adhesive layer at the time of putting the pressure-sensitive adhesive layer attached first polarizing film in a humidity environment of 60° C. and 95%RH for 250 hours, drying the pressure-sensitive adhesive layer attached first polarizing film at 40° C. for 1 hour, and subsequently peeling off the separator. If the variation ratio (b/a) is more than 5, the pressure-sensitive adhesive layer is lowered in antistatic function in a humidity environment. The variation ratio (b/a) is preferably 5 or less, more preferably 3.5 or less, even more preferably 2.5 or less, even more preferably 2 or less, most preferably 1.5 or less.

About the proportion of the ionic compound (B), the amount thereof is preferably, for example, 0.01 part or more by weight for 100 parts by weight of the (meth) acrylic polymer (A). The use of the ionic compound (B) in an amount of 0.01 part or more by weight favorably improves the pressure-sensitive adhesive layer in antistatic performance. From this viewpoint, the amount of the ionic compound (B) is preferably 0.1 part or more by weight, more preferably 0.5 part or more by weight. In the meantime, if the amount of the ionic compound (B) becomes large, the surface resistance value becomes too low. Consequently, there is caused a base line variation (a malfunction when a touch is made on the panel, this malfunction being caused by an excessive lowness of the surface resistance value), so that the touch panel may be unfavorably lowered in sensitivity. Moreover, if the amount of the ionic compound (B) becomes large, the ionic compound (B) may be precipitated and further the pressure-sensitive adhesive layer may easily be peeled off in humidity. For these viewpoints, usually, the amount of the ionic compound (B) is preferably 40 parts or less by weight, more preferably 30 parts or less by weight, even more preferably 20 parts or less by weight, most preferably 10 parts or less by weight.

The pressure-sensitive-adhesive composition of the present invention may include a crosslinking agent (C). The crosslinking agent (C) may be an organic crosslinking agent or a polyfunctional metal chelate. Examples of the organic crosslinking agent include isocyanate crosslinking agents, peroxide crosslinking agents, epoxy crosslinking agents, and imine crosslinking agents. The polyfunctional metal chelate is a substance in which a polyvalent metal is bonded to an organic compound through covalent bonding or coordinate bonding. Examples of the polyvalent metal include Al, Cr, Zr, Co, Cu, Fe, Ni, V, Zn, In, Ca, Mg, Mn, Y, Ce, Sr, Ba, Mo, La, Sn, and Ti. The atom in the organic compound which is subjected to the covalent bonding or coordinate bonding is, for example, an oxide atom. Examples of the organic compound include alkyl esters, alcohol compounds, carboxylic acid compounds, ether compounds, and ketone compounds.

The crosslinking agent (C) is preferably an isocyanate crosslinking agent and/or a peroxide crosslinking agent.

The isocyanate crosslinking agent (C) may be a compound having at least two isocyanate groups. For example, a known polyisocyanate used generally in urethanization reaction is used, examples thereof including aliphatic polyisocyanates, alicyclic polyisocyanates, and aromatic polyisocyanates.

As the peroxide, an appropriately selected peroxide is usable as far as the peroxide is a peroxide which is heated or irradiated with light to generate a radical active species to advance the crosslinkage of the base polymer of the pressure-sensitive-adhesive composition. Considering the workability and stability of the peroxide, it is preferred to use a peroxide about which the one-minute half-life temperature is from 80 to 160° C. More preferably, a peroxide about which the temperature is from 90 to 140° C. is used.

Usable examples of the peroxide include di (2-ethylhexyl) peroxydicarbonate (one-minute half-life temperature: 90.6° C.), di (4-t-butylcyclohexyl) peroxydicarbonate (1 minute half-life temperature: 92.1° C.), di-sec-butyl peroxydicarbonate (one-minute half-life temperature: 92.4° C.), t-butyl peroxyneodecanoate (one-minute half-life temperature: 103.5° C.), t-hexyl peroxypivalate (one-minute half-life temperature: 109.1° C.), t-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutylperoxy-2-ethyl hexanoate (one-minute half-life temperature: 124.3° C.), di (4-methylbenzoyl) peroxide (one-minute half-life temperature: 128.2° C.), dibenzoyl peroxide (one-minute half-life temperature: 130.0° C.), t-butyl peroxyisobutyrate (one minute half-life temperature: 136.1° C.), and 1,1-di (t-hexylperoxy) cyclohexane (one-minute half-life temperature: 149.2° C.). Out of these examples, particularly preferred are di (4-t-butylcyclohexyl) peroxydicarbonate (one-minute half-life temperature : 92.1° C.), dilauroyl peroxide (one-minute half-life temperature: 116.4° C.), and dibenzoyl peroxide (one-minute half-life temperature: 130.0° C.) since these compounds are excellent in crosslinking reaction efficiency.

The use amount of the cross linking agent (C) is preferably 3 parts or less by weight, more preferably from 0.01 to 3 parts by weight, even more preferably from 0.02 to 2 parts by weight, even more preferably from 0.03 to 1 part by weight for 100 parts by weight of the (meth) acrylic polymer (A). If the amount of the crosslinking agent (C) is less than 0.01 part by weight, the crosslinkage of the pressure-sensitive adhesive layer is insufficient so that the layer may not unfavorably satisfy endurance and adhesive properties. If the amount is more than 3 parts by weight, the pressure-sensitive adhesive layer tends to be excessively hard to be lowered in endurance.

The pressure-sensitive-adhesive composition of the present invention may include a silane coupling agent (D). The use of the silane coupling agent (D) can improve the endurance of the pressure-sensitive adhesive layer. Specific examples of the silane coupling agent include 3-glycidoxypropyltrimethoxysilane, 3-glycidoxypropyltriethoxysilane, 3-glycidoxypropylmethyldiethoxysilane, 2-(3,4-epoxycyclohexyl) ethyltrimethoxysilane, and other epoxy-group-containing silane coupling agents; 3-aminopropyltrimethoxysilane, N-2-(aminoethyl)-3-aminopropylmethyldimethoxysilane, 3-triethoxysilyl-N-(1,3-dimethylbutylidene) propylamine, N-phenyl-γ-aminopropyltrimethoxysilane, and other amino-group-containing silane coupling agents; 3-acryloxypropyltrimethoxysilane, 3-methacryloxypropyltriethoxysilane, and other (meth) acryl-group-containing silane coupling agents; and 3-isocyanatopropyltriethoxysilane, and other isocyanate-group-containing silane coupling agents. Out of the silane coupling agents given as the examples, epoxy-group-containing silane coupling agents are preferred.

The silane coupling agent (D) may be a silane coupling agent having a molecule having therein plural alkoxysilyl groups. Specific examples thereof include products X-41-1053, X-41-1059A, X-41-1056, X-41-1805, X-41-1818, X-41-1810, and X-40-2651 manufactured by Shin-Etsu Chemical Co., Ltd. These silane coupling agents, which each have in the molecule thereof plural alkoxysilyl groups, are favorable since the agents do not vaporize easily, and are effective for improving the pressure-sensitive adhesive layer in endurance because of the plural alkoxysilyl groups which the agent each have. The endurance is favorable, particularly, when an adherend of the pressure-sensitive adhesive layer attached optical film is a transparent, conductive layer (made of, for example, ITO) which is less reactive with the alkoxysilyl groups than glass. The silane coupling agent having a molecule having therein plural alkoxysilyl groups is preferably an agent having in the molecule an epoxy group. The silane coupling agent is more preferably an agent having in the molecule thereof plural epoxy groups. The silane coupling agent having in the molecule plural alkoxysilyl groups and one or more epoxy groups tends to be good in endurance also when the adherend is a transparent conductive layer (made of, for example, ITO). Specific examples of the silane coupling agent, which has in the molecule plural alkoxysilyl groups and one or more epoxy groups, include products X-41-1053, X-41-1059 A, and X-41-1056. Particularly preferred is the product X-41-1056 manufactured by Shin-Etsu Chemical Co., Ltd., in which the proportion of the contained epoxy groups is large.

These silane coupling agents (D) may be used singly or in the form of a mixture of two or more thereof. The content of the whole of the agent (s) is preferably 5 parts or less by weight, more preferably from 0.001 to 5 parts by weight, even more preferably from 0.01 to 1 part by weight, even more preferably from 0.02 to 1 part by weight, even more preferably from 0.05 to 0.6 part by weight for 100 parts by weight of the (meth) acrylic polymer (A). Such an amount is an amount which makes an improvement of the pressure-sensitive adhesive layer in endurance.

Into the pressure-sensitive-adhesive composition of the present invention maybe blended a polyether compound (E) having a reactive silyl group. The polyether compound (E) is favorable since the pressure-sensitive-adhesive composition can be improved in re-workability. The polyether compound (E) maybe, for example, any polyether compound disclosed in JP-A-2010-275522.

About the proportion of the polyether compound (E) in the pressure-sensitive-adhesive composition of the present invention, the amount of the component (E) is preferably 10 parts or less by weight, preferably from 0.001 to 10 parts by weight for 100 parts by weight of the (meth) acrylic polymer (A). If the amount of the polyether compound (E) is less than 0.001 part by weight, the re-workability improving effect may not be sufficient. The amount of the polyether compound (E) is preferably 0.01 part or more by weight, more preferably 0.1 part or more by weight. If the amount of the polyether compound (E) is more than 10 parts by weight, the resultant pressure-sensitive adhesive layer is unfavorable in endurance. The amount of the polyether compound (E) is preferably 5 parts or less by weight, more preferably 2 parts or less by weight. The proportion of the polyether compound (E) can be set into a preferred range in which any one of the above-mentioned upper value or lower value is adopted.

The pressure-sensitive-adhesive composition of the present invention may further contain other known dopants. For example, the following may be appropriately added to the composition in accordance with the usage thereof: a polyether compound of a polyalkylene glycol, such as polypropylene glycol, a colorant, a powder such as pigment, a dye, a surfactant, a plasticizer, a tackifier, a surface lubricant, a levelling agent, a softener, an antioxidant, an antiaging agent, a light stabilizer, an ultraviolet absorbent, a polymerization inhibitor, an inorganic or organic filler, a metallic powder, or a particle-or foil-form material. A redox system to which a reductant is added may be adopted as far as the system can be controlled. It is preferred to use these dopants in an amount that is preferably 5 parts or less by weight, more preferably 3 parts or less by weight, even more preferably 1 part or less by weight for 100 parts by weight of the (meth) acrylic polymer (A).

The first pressure-sensitive adhesive layer 21 in the present invention is usable in the form of a pressure-sensitive adhesive layer attached optical film in which this layer is bonded to an optical film (polarizing film). The pressure-sensitive adhesive layer attached optical film can be yielded by forming a pressure-sensitive adhesive layer made of the pressure-sensitive-adhesive composition onto at least one surface of an optical film.

The method for forming the pressure-sensitive adhesive layer is, for example, a method of applying the pressure-sensitive-adhesive composition onto, for example, a separator subjected to release treatment, drying the resultant to remove a polymerizing solvent and others therein to form at pressure-sensitive adhesive layer, and then transferring the resultant onto an optical film (polarizing film); or a method of applying the pressure-sensitive-adhesive composition onto an optical film (polarizing film), and drying the resultant to remove a polymerizing solvent and others therein to form a pressure-sensitive adhesive layer onto the optical film. In the application of the pressure-sensitive adhesive, one or more solvents other than the polymerizing solvent may be newly added appropriately to the pressure-sensitive adhesive.

The thickness of the first pressure-sensitive adhesive layer 21 is not particularly limited, and is, for example, from about 1 to 100 μm. The thickness is preferably from 2 to 50 μm, more preferably from 2 to 40 μm, even more preferably from 5 to 35 μm.

### EXAMPLES

Hereinafter, the present invention will be specifically described by way of Examples thereof.

However, the invention is not limited to these Examples. In each of the examples, the word “part (s)” and the symbol “%” are part(s) by weight and % by weight, respectively. Conditions for allowing any object to stand still at room temperature are at 23° C. and 65%RH unless otherwise specified.

<Measurement of Weight-Average Molecular Weight of (Meth)Acrylic Polymer (A)>

The weight-average molecular weight (Mw) of a (meth) acrylic polymer (A) was measured by GPC (gel permeation chromatography). The Mw/Mn ratio was also measured in the same way.
Analyzing device: HLC-8120GPC, manufactured by Tosoh Corp.
Columns: G7000H_{XL}+GMH_{XL}+GMH_{XL}, manufactured by Tosoh Corp.
Size of each of the columns: 7.8 mn in diameter×30 cm in length;
total length: 90 cm
Column temperature: 40° C.
Flow rate: 0.8 mL/min.
Injected volume: 100 μL
Eluent: tetrahydrofuran
Detector: differential reflector (RI)
Standard sample: polystyrene

### <Production of Polarizing Film P1>

A polyvinyl alcohol film having a thickness of 80 μm was stretched 3 times between rolls different from each other in speed rate while dyed with an iodine solution having a concentration of 0.3% and a temperature of 30° C. for 1 minute. Thereafter, the film was stretched into a total stretch ratio of 6 while immersed in an aqueous solution of 60° C. which contained boric acid in a concentration of 4% and potassium iodide in a concentration of 10% for 0.5 minute. Next, the film was immersed in an aqueous solution of 30° C. which contained potassium iodide in a concentration of 1.5% for 10 seconds to be washed, and then the film was dried at 50° C. for 4 minutes to yield a polarizer of 30 μm thickness. A polyvinyl alcohol based adhesive was used to bond, onto each of the two surfaces of the polarizer, a (meth) acrylic resin film subjected to corona treatment and having a thickness of 20 μm and having a lactone ring structure as a transparent protective film to produce each polarizing film P1.

<Production of Each Polarizing Film P2>

Each polarizing film P2 was yielded in the same way as used to produce the polarizing film P1 except, that as the transparent protective film, a saponified triacetylcellulose film of 80 μm thickness was used.

### Example 1

### (Preparation of Acrylic Polymer (A))

Into a four-necked flask equipped with stirring fans, a thermostat, a nitrogen introducing tube and a condenser was charged a monomer mixture composed of 75.8 parts by butyl acrylate, 23 parts of phenoxyethyl acrylate, 0.5 part of N-vinyl-2-pyrrolidone (NVP), 0.3 part of acrylic acid, and 0.4 part of 4-hydroxybutyl acrylate. Furthermore, into 100 parts by (solid in) the monomer mixture were charged 100 parts of ethyl acetate together with 0.1 part of 2,2′-azobisisobutyronitrile as a polymerization initiator. While gently stirred, nitrogen gas was introduced into the flask to purge the inside thereof with nitrogen. Thereafter, while the liquid temperature of the inside of the flask was kept about 55° C., the polymerizable components were caused to undergo a polymerization reaction for 8 hours to prepare an acrylic polymer (A) having a weight-average molecular weight (Mw) of 1600000 and a Mw/Mn ratio of 3.7.

### (Preparation of Pressure-Sensitive-Adhesive Composition)

The following were blended into 100 parts of solid in the acrylic polymer (A1) solution yielded in Production Example 1: 0.1 part of bis (trifluoromethanesulfonyl) imide lithium (Li-TFSI) manufactured by Mitsubishi Materials Corp. as an ionic compound; 0.1 part of an isocyanate crosslinking agent (trimethylolpropanehexamethylene diisocyanate: TAKENATE D160N, manufactured by Mitsui Chemicals, Inc.); 0.3 part of benzoyl peroxide (NYPER BMT, manufactured by NOF Corp.); and 0.3 part of an epoxy-group-containing silane coupling agent (X-41-1056, manufactured by Shin-Etsu Chemical Co., Ltd.). In this way, a solution of an acrylic pressure-sensitive-adhesive composition was prepared.

### (Production of Pressure-Sensitive Adhesive Layer Attached Polarizing Film)

Next, the acrylic pressure-sensitive adhesive composition solution was applied onto a single surface of a polyethylene terephthalate film treated with a silicone release agent (separator film: MRF 38, manufactured by Mitsubishi Polyester Film, Inc.) to give a pressure-sensitive adhesive layer thickness of 20 μm after the resultant would be dried. This resultant was dried at 155° C. for 1 minute to form a pressure-sensitive adhesive layer onto the front surface of the separator film. Next, the pressure-sensitive adhesive layer formed on the separator film was transferred onto the polarizing film P1 produced as described above to produce each pressure-sensitive adhesive layer attached polarizing film.

### Examples 2 to 14, and Comparative Examples 1 to 6

In each of the examples, an acrylic polymer solution and an acrylic pressure-sensitive-adhesive composition solution were prepared in the same way as in Example 1 except that one or more of the following were changed as shown in Table 1: the use amount of N-vinyl-2-pyrrolidone (NVP) used to prepare the acrylic polymer (A) in the monomer mixture; the kinds or the blend proportion of the ionic compound (Li-TFSI or MPP-TFSI) used to prepare the pressure-sensitive-adhesive composition; and the kinds of the polarizing film. Moreover, the acrylic pressure-sensitive-adhesive composition solution was used to produce each pressure-sensitive adhesive layer attached polarizing film in the same way as in Example 1.

About the pressure-sensitive adhesive layer attached polarizing films yielded in each of the Examples and the Comparative examples, evaluations described below were made. The evaluation results are shown in Table 1. In each of the evaluations, any “initial value” is a value measured immediately after the production of the corresponding pressure-sensitive adhesive layer attached polarizing film: and “value after humidification” is a value measured after the corresponding resultant pressure-sensitive adhesive layer attached polarizing film was put in a humidity environment of 60° C. and 95%RH for 250 hours, and further the polarizing film was dried at 40° C. for 1 hour.

### <Surface Resistance Value (Ω/□): Electroconductivity>

The separator film was peeled off from one of the pressure-sensitive adhesive layer attached polarizing films of each of the examples, and subsequently the surface resistance value of the front surface of the pressure-sensitive adhesive layer was measured. The measurement was made, using a device MCP-HT450 manufactured by Mitsubishi Chemical Analytech Co., Ltd.

In Table 1, the variation ratio (b/a) of each of the pressure-sensitive adhesive layer attached polarizing films is a value (rounded off to the second decimal place) calculated from the surface resistance value (a) as the “initial value” and the surface resistance value (b) as the “value after humidification”.

For an index showing that the possibility is small that the pressure-sensitive adhesive layer attached polarizing film causes a malfunction of a liquid crystal panel, the matter that the film is more favorable as the variation ratio thereof is a smaller value is judged in accordance with the following criterion:

⊙: The variation ratio is 2 or less.

◯: The variation ratio is more than 2, and less than 5.

x: The variation ratio is 5 or more.

### <ESD Test>

The separator film was peeled off from one of the pressure-sensitive adhesive layer attached polarizing films of each of the examples, and subsequently the film was bonded onto a viewing side of an on-cell liquid crystal cell or an in-cell liquid crystal cell as shown in Table 1 to produce a liquid crystal panel incorporated with touch sensing function. Specifically, any one of the pressure-sensitive adhesive layer attached polarizing films yielded in each of Examples 1 to 3, 6 to 10, and 14, and Comparative examples 1 to 6 was bonded to the sensor layer (touch sensor section) of the on-cell liquid crystal cell illustrated in FIG. 3 to form a first pressure-sensitive adhesive layer and a first polarizing film. Any one of the pressure-sensitive adhesive layer attached polarizing films yielded in each of Examples 4, 5 and 11 to 13 was bonded to the first transparent substrate of the in-cell liquid crystal cell illustrated in FIG. 1 to form a first pressure-sensitive adhesive layer and a first polarizing film. An ESD (electrostatic discharge) gun (10 kV) was shot onto the polarizing film surface of the liquid crystal panel, and then a measurement was made about a period until void areas made into a white color by the electricity disappeared. The result was judged in accordance with the following criterion:

### (Evaluation Criterion)

⊙: The period is 3 seconds or shorter.

◯: The period is longer than 3 seconds, and 10 seconds or shorter.

x: The period is longer than 10 seconds.

TABLE 1

| | | Use | | | | | | | | | |
|---|---|---|---|---|---|---|---|---|---|---|---|
| | | amount | | | | | | | | | |
| | | (part(s) by | Ionic | | | | | | | | |
| | | weight) of | compound (B) | | Evaluations | | | | | | |
| | | amide- | | Blend | Surface resistance value | | | | | | |
| | | group- | | amount | (Ω/□) | | | | ESD evaluation | | |
| | | containing | | (part(s) | | | Variation | | Evaluating | | |
| | Polarizing | monomer | | by | Initial | Value (b) after | ratio | | panel | | After |
| | film kinds | (a2): NVP | Kinds | weight) | value (a) | humidification | (b/a) | Malfunctions | kinds | Initial | humidification |
| Example 1 | P1 | 0.5 | Li-TFSI | 0.1 | 7.0E+11 | 7.0E+11 | 1.0 | ⊙ | On-cell | ◯ | ◯ |
| Example 2 | P1 | 3 | Li-TFSI | 0.1 | 3.5E+11 | 4.0E+11 | 1.1 | ⊙ | On-cell | ⊙ | ⊙ |
| Example 3 | P1 | 3 | Li-TFSI | 0.5 | 1.0E+11 | 1.3E+11 | 1.3 | ⊙ | On-cell | ⊙ | ⊙ |
| Example 4 | P1 | 3 | Li-TFSI | 5 | 8.0E+09 | 1.2E+10 | 1.5 | ⊙ | In-cell | ⊙ | ◯ |
| Example 5 | P1 | 3 | Li-TFSI | 40 | 9.4E+08 | 1.9E+09 | 2.0 | ⊙ | In-cell | ⊙ | ⊙ |
| Example 6 | P2 | 0.5 | Li-TFSI | 0.1 | 7.2E+11 | 9.0E+11 | 1.3 | ⊙ | On-cell | ◯ | ◯ |
| Example 7 | P2 | 3 | Li-TFSI | 0.1 | 3.7E+11 | 6.0E+11 | 1.6 | ⊙ | On-cell | ⊙ | ◯ |
| Example 8 | P2 | 3 | Li-TFSI | 0.5 | 1.7E+11 | 3.5E+11 | 2.1 | ◯ | On-cell | ⊙ | ⊙ |
| Example 9 | P2 | 3 | Li-TFSI | 1 | 4.3E+10 | 1.5E+11 | 3.5 | ◯ | On-cell | ⊙ | ⊙ |
| Example 10 | P1 | 3 | MPP-TFSI | 0.5 | 4.0E+11 | 5.2E+11 | 1.3 | ⊙ | On-cell | ⊙ | ⊙ |
| Example 11 | P1 | 3 | MPP-TFSI | 5 | 4.8E+09 | 6.7E+09 | 1.4 | ⊙ | In-cell | ⊙ | ⊙ |
| Example 12 | P1 | 8 | MPP-TFSI | 13 | 8.0E+08 | 1.2E+09 | 1.5 | ⊙ | In-cell | ⊙ | ⊙ |
| Example 13 | P1 | 8 | MPP-TFSI | 13 | 8.3E+08 | 1.2E+09 | 1.5 | ⊙ | In-cell | ⊙ | ⊙ |
| Example 14 | P1 | 8 | MPP-TFSI | 0.5 | 3.8E+11 | 4.9E+11 | 1.3 | ⊙ | On-cell | ⊙ | ⊙ |
| Comparative | P1 | 0 | Li-TFSI | 1.5 | 6.0E+10 | 4.0E+11 | 6.7 | X | On-cell | ⊙ | ⊙ |
| example 1 | | | | | | | | | | | |
| Comparative | P1 | 0 | Li-TFSI | 5 | 2.0E+10 | 3.0E+11 | 15.0 | X | On-cell | ⊙ | ⊙ |
| example 2 | | | | | | | | | | | |
| Comparative | P1 | 0 | Li-TFSI | 10 | 8.0E+09 | 2.0E+11 | 25.0 | X | On-cell | ⊙ | ⊙ |
| example 3 | | | | | | | | | | | |
| Comparative | P2 | 0 | Li-TFSI | 1.5 | 1.2E+11 | 1.0E+12 | 8.3 | X | On-cell | ⊙ | X |
| example 4 | | | | | | | | | | | |
| Comparative | P2 | 0 | Li-TFSI | 5 | 8.3E+10 | 1.5E+12 | 18.1 | X | On-cell | ⊙ | X |
| example 5 | | | | | | | | | | | |
| Comparative | P2 | 0 | Li-TFSI | 10 | 3.0E+10 | 8.4E+11 | 28.0 | X | On-cell | ⊙ | ◯ |
| example 6 | | | | | | | | | | | |

In Table 1, Li-TFSI represents bis (trifluoromethansulfonyl) imide lithium; and

MPP-TFSI, 1-methyl-1-propylpyrrolidinium bis (trifluoromethansulfonyl) imide (manufactured by Toyo Gosei Co., Ltd).

As shown in Table 1, the following is understood from the description about the Examples and the Comparative examples: as in the Examples, an ionic compound is blended into an acrylic polymer, whereby the variation ratio of the surface resistance value of the pressure-sensitive adhesive layer after this layer is humidified is adjusted to 5 or less to restrain the surface resistance value from being raised, also when the initial surface resistance value of the pressure-sensitive adhesive layer is set to a low value, by the matter that the acrylic polymer has an amide-group-containing monomer as a monomer unit. In other words, in the Examples, the variation ratio of the surface resistance value of their pressure-sensitive adhesive layer is small so that even after humidified, this layer can maintain the surface resistance value within a desired range. Thus, the pressure-sensitive adhesive layer can keep the sensitivity of the resultant touch panel good. Furthermore, the pressure-sensitive adhesive layer is good against the ESD test so that the panel can restrain electrostatic unevenness.

### DESCRIPTION OF REFERENCE SIGNS

11,. 12: First and second polarizing films

21, 22: First and second pressure-sensitive adhesive layers

3: Liquid crystal layer

41, 42: First and second transparent substrates

5: Touch sensor section

6: Driving-electrode-concurrently-functioning sensor section

7: Driving electrode

C: Liquid crystal cell

1. A liquid crystal panel incorporated with touch sensing function, comprising:
a liquid crystal cell incorporated with touch sensing function, having a liquid crystal layer and a touch sensor section;
a first polarizing film arranged on a viewing side of the liquid crystal cell and a second polarizing film arranged on a side of the liquid crystal cell that is opposite to the viewing side; and
a first pressure-sensitive adhesive layer arranged between the first polarizing film and the liquid crystal cell,
wherein the first pressure-sensitive adhesive layer comprises
a pressure-sensitive-adhesive composition comprising a (meth)acrylic polymer (A) comprising, as monomer units thereof, an alkyl (meth)acrylate (a1) and an amide-group-containing monomer (a2), and an ionic compound (B), and
the first pressure-sensitive adhesive layer satisfies the following: “the variation ratio (b/a) of the surface resistance value thereof”≤5 wherein the symbol “a” represents the surface resistance value of the first pressure-sensitive adhesive layer at the time of producing the pressure-sensitive adhesive layer attached first polarizing film in a state that the first pressure-sensitive adhesive layer is laid on the first polarizing film and further a separator is disposed on the first pressure-sensitive adhesive layer, and peeling off the separator immediately after the production; and the symbol “b” represents the surface resistance value of the first pressure-sensitive adhesive layer at the time of putting the pressure-sensitive adhesive layer attached first polarizing film in a humidity environment of 60° C. and 95% RH for 250 hours, drying the pressure-sensitive adhesive layer attached first polarizing film at 40° C. for 1 hour, and subsequently peeling off the separator.

2. The liquid crystal panel incorporated with touch sensing function according to claim 1, wherein the amide-group-containing monomer (a2) is an N-vinyl-group-containing lactam monomer.

3. The liquid crystal panel incorporated with touch sensing function according to claim 1, wherein the amide-group-containing monomer (a2) is comprised, as one of the monomer units, in the (meth)acrylic polymer (A) in a proportion of 0.1% or more by weight.

4. The liquid crystal panel incorporated with touch sensing function according to claim 1, wherein the ionic compound (B) is an alkali metal salt.

5. The liquid crystal panel incorporated with touch sensing function according to claim 1, wherein the sonic compound (B) is comprised in an amount of 0.01 part or more by weight for 100 parts by weight of the (meth)acrylic polymer (A).

6. The liquid crystal panel incorporated with touch sensing function according to claim 1, wherein the touch sensor section directly contacts the first pressure-sensitive adhesive layer.

7. A liquid crystal display device, comprising the liquid crystal panel incorporated with touch sensing function according to to claim 1.
